(19) United States
(12) Patent Application Publication
(10) Pub. No.: US 2013/0315041 A1
(43) Pub. Date: Nov. 28, 2013

(54) Generating Calendar Alarm Notifications Based on User Working Hours and Status

(71) Applicants: Shobha Hiremath, Westford, MA (US); Shruti Kumar, Littleton, MA (US); Fang Lu, Billerica, MA (US); Azadeh Salehi, Littleton, MA (US)

(72) Inventors: Shobha Hiremath, Westford, MA (US); Shruti Kumar, Littleton, MA (US); Fang Lu, Billerica, MA (US); Azadeh Salehi, Littleton, MA (US)

(73) Assignee: INTERNATIONAL BUSINESS MACHINES CORPORATION, Armonk, NY (US)

(21) Appl. No.: 13/478,349

(22) Filed: May 23, 2012

(51) Int. Cl. G04B 47/00

(52) U.S. Cl. 368/10

(57) ABSTRACT

Methods and systems of managing calendar alarm notifications may provide for identifying a calendar entry and identifying a working hour range. Additionally, an alarm notification may be scheduled for the calendar entry based on the working hour range. In one example, if it is determined that the calendar entry is scheduled either outside the working hour range or at a beginning of the working hour range, the alarm notification is adapted to occur within the working hour range.

### BACKGROUND

Embodiments of the present invention generally relate to calendar alarm notifications. More particularly, embodiments relate to the automatic scheduling of calendar alarm notifications based on user working hours and user status information.

Calendaring software may be used to schedule meetings electronically, wherein certain calendaring software solutions may remind/notify the user in advance of upcoming meetings. While many users may simply accept a default setting for the alarm notification (e.g., thirty minutes before the meeting), such an approach might be inadequate in certain circumstances. For example, if the meeting is scheduled after the user's normal working hours, the user may not be logged into or near the computing device that is used to receive notifications. Accordingly, the meeting alarm notification may go undelivered and/or unnoticed, and the user could actually miss the meeting altogether.

Although some calendaring software solutions may enable the user to manually select a different alarm notification setting, there remains considerable room for improvement. For example, such a change may typically need to be made manually each time a meeting is scheduled. Moreover, if the user's working hours change due to, for example, travel or personal emergencies, the alarm notification setting may also need to be updated manually by the user.

### BRIEF SUMMARY

Embodiments may include a computer program product having a computer readable storage medium and computer usable code stored on the computer readable storage medium. If executed by a processor, the computer usable code may cause a computer to identify a first calendar entry and identify a working hour range. In addition, the computer usable code can also cause a computer to schedule an alarm notification for the first calendar entry based on the working hour range.

Embodiments may also include a computer implemented method in which a request to create a first calendar entry is received via a user interface. The method can provide for creating the first calendar entry in response to the request, and obtaining a working hour range from a user profile. It may be determined that the first calendar entry is scheduled either outside the working hour range or at a beginning of the working hour range. The method may also involve identifying a time range associated with a second calendar entry, and scheduling an alarm notification for the first calendar entry, wherein the alarm notification is to occur within the working hour range and outside the time range associated with the second calendar entry. Additionally, the method can provide for detecting a status change with respect to a user associated with the first calendar entry, and re-scheduling the alarm notification in response to the status change.

Embodiments may also include a computer program product having a computer readable storage medium and computer usable code stored on the computer readable storage medium. If executed by a processor, the computer usable code may cause a computer to receive a request to create a first calendar entry via a user interface, create the first calendar entry in response to the request, and obtain a working hour range from a user profile. In addition, the computer usable code can cause a computer to determine that the first calendar entry is scheduled either outside the working hour range or at a beginning of the working hour range, identify a time range associated with a second calendar entry, and schedule an alarm notification for the first calendar entry, wherein the alarm notification is to occur within the working hour range and outside the time range associated with the second calendar entry. Moreover, the computer usable code may cause a computer to detect a status change with respect to a user associated with the first calendar entry, and re-schedule the alarm notification in response to the status change.

### BRIEF DESCRIPTION OF THE SEVERAL VIEWS OF THE DRAWINGS

The various advantages of the embodiments of the present invention will become apparent to one skilled in the art by reading the following specification and appended claims, and by referencing the following drawings, in which:

FIG. 1 is a preference setting user interface according to an embodiment;

FIG. 2 is a flowchart of an example of a method of scheduling alarm notifications according to an embodiment;

FIG. 3 is a flowchart of an example of a method of re-scheduling alarm notifications in response to user status changes according to an embodiment;

FIG. 4A is a block diagram of an example of an adaptation of an alarm notification in response to a working hours change according to an embodiment;

FIG. 4B is a block diagram of an example of an adaptation of an alarm notification in response to a time zone change according to an embodiment; and

FIG. 5 is a block diagram of an example of a computing device according to an embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

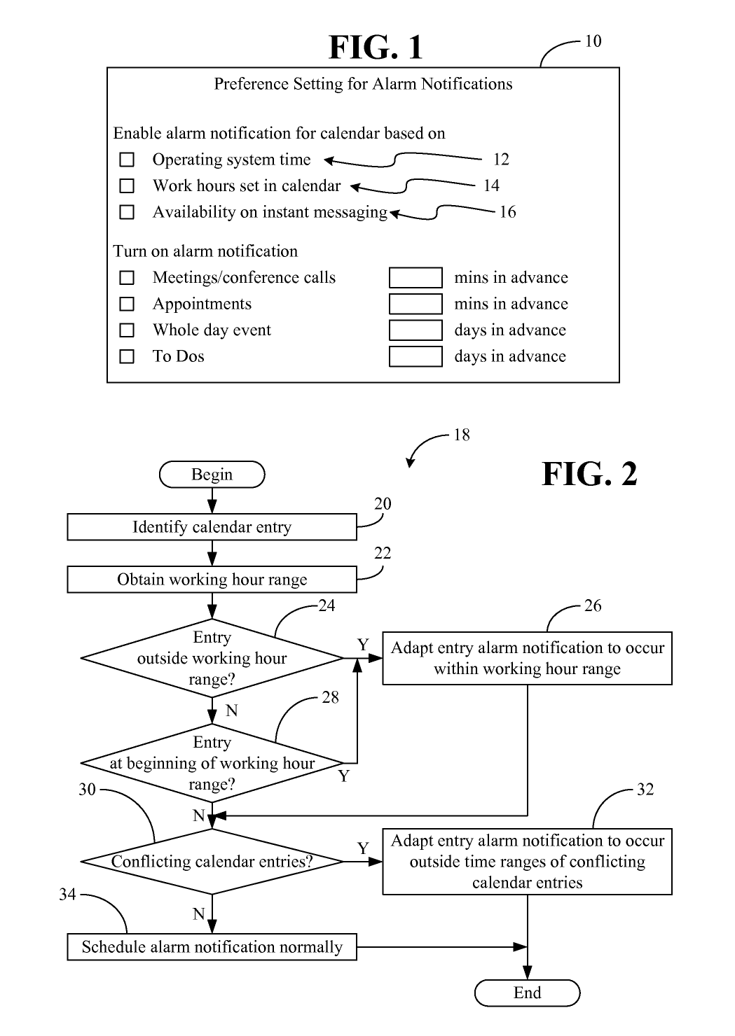

Referring now to FIG. 1, a user interface 10 is shown in which calendar alarm notification preferences may be configured by a user of an electronic calendaring tool. In the illustrated example, the alarm notification preferences include an operating system (OS) time setting 12, a working hour range setting 14, and a user status setting 16. Moreover, specific alarm notification time periods may be configured for meetings/conference calls, appointments, whole day events, and “to dos” (e.g., tasks), in the example shown. As will be discussed in greater detail, alarm notifications for scheduled events can be automatically adapted and/or re-scheduled according to the settings 12, 14, 16. For example, selecting the box next to the OS time setting 12 may cause the calendaring tool to automatically re-schedule alarm notifications in response to time zone changes (e.g., mobile device network time changes), selecting the box next to the working hour range setting 14 may cause the calendaring tool to automatically schedule and/or reschedule alarm notifications to occur during the working hours of the user, and selecting the box next to the user status setting 16 may cause the calendaring tool to automatically re-schedule and/or trigger alarm notifications in response to changes in the instant messaging (IM) status of the user.

FIG. 2 shows a method 18 of scheduling alarm notifications. The method 18 might be implemented, for example, in an electronic calendaring tool configured to run on a user device, server, or any combination thereof. Illustrated processing block 20 provides for identifying a calendar entry such as a meeting, conference call, appointment, and so forth. The calendar entry could be identified in conjunction with the creation of the calendar entry, on a periodic basis (e.g., daily for all meetings that have not yet occurred), or in response to one or more triggering conditions (e.g., working hours change, time zone change), as will be discussed in greater detail. The working hour range of a user can be obtained at block 22, wherein the working hour range may generally identify time periods during which the user expects to be working (e.g., 9 am-5 pm). In one example, the working hour range is obtained by accessing a user profile, although other approaches can be used.

More particularly, block 22 may identify the day of the calendar entry and obtain the user's working hour range for that day. If it is determined at block 24 that the calendar entry is outside the working hour range of the user, illustrated block 26 adapts an alarm notification for the calendar entry to occur within the working hour range. For example, if the user plans to work from 9 am to 5 pm on the day of the calendar entry, and the calendar entry is a meeting scheduled at 7 pm, the alarm notification might be scheduled to occur at 4:30 pm (e.g., if the user requests to be notified thirty minutes in advance of meetings). Of particular note is that such an approach would reduce the likelihood of the user missing the alarm notification and/or the meeting because the alarm notification might otherwise be scheduled for 6:30 pm, when the user is not planning to be working.

If it is determined at block 28 that the calendar entry is scheduled to occur at the beginning of the working hour range of the user, the alarm notification may also be adapted at block 26 to occur within the working hour range. For example, if the user plans to work from 9 am to 5 pm on the day of the calendar entry, and the calendar entry is a meeting scheduled at 9 am, the alarm notification might be scheduled to occur at 4:30 pm on the day before the meeting. Similarly, such an approach can reduce the likelihood of the user missing alarm notification and/or the meeting because the alarm notification might otherwise be scheduled for 8:30 am, when the user is not planning to be working.

Illustrated block 30 determines whether any other calendar entries conflict with the alarm notification. If so, the alarm notification may be adapted at block 32 to also occur outside the time ranges associated with any such conflicting calendar entries. For example, if the alarm notification is scheduled to occur at 4:30 pm and the user has another appointment scheduled from 4:00 pm to 5:00 pm, block 32 may provide for adjusting the alarm notification to occur at 3:30 pm (i.e., before the user enters the 4:00 pm appointment). If there are no conflicting entries, block 34 can schedule the alarm notification normally and/or leave the alarm notification unchanged.

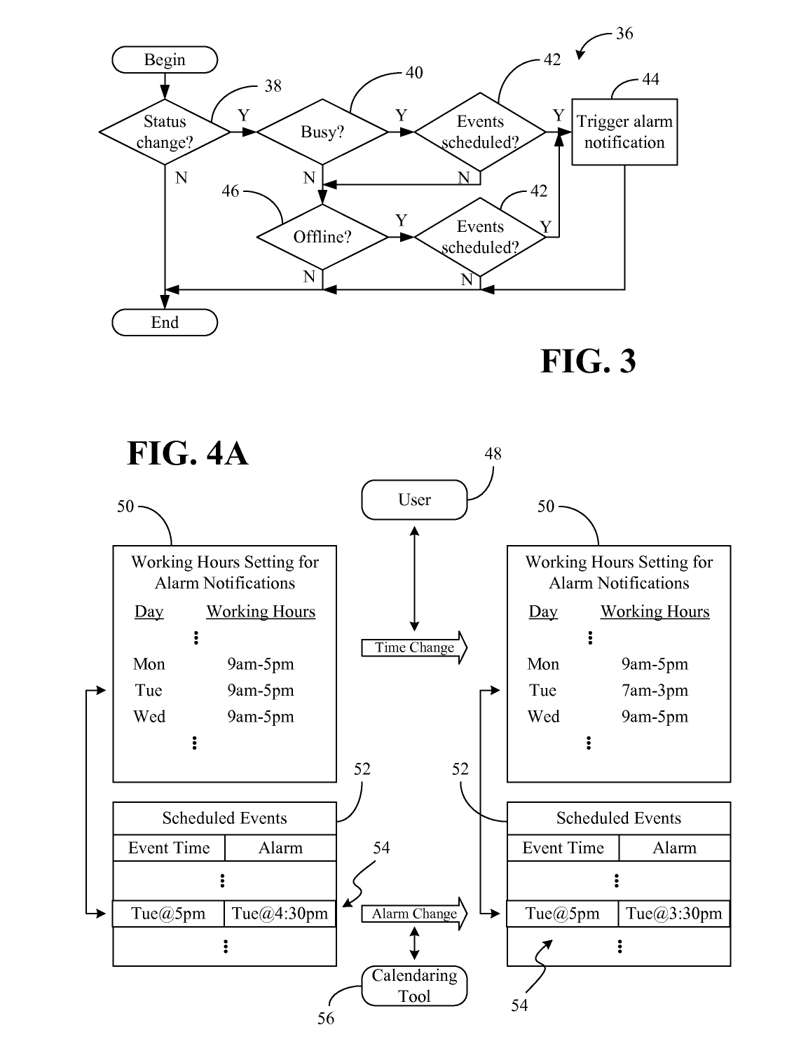

Turning now to FIG. 3, a method 36 of re-scheduling calendar alarm notifications in response to user status changes is shown. In the illustrated example, a determination is made at block 38 as to whether the IM status of the user has changed. If so, block 40 may determine whether the user is busy, wherein a determination can be made at block 42 as to whether any upcoming calendar events are scheduled (e.g., within a predetermined range of time such as one hour). In response to detecting any such upcoming events, illustrated block 44 re-schedules the alarm notifications associated with those events to occur immediately. Thus, if the user changes his or her IM status to busy an hour before a meeting and thirty minutes before the alarm notification is scheduled to occur for that meeting, the illustrated approach may effectively accelerate the delivery of the alarm notification to reduce the likelihood that the user will miss the alarm notification and/or meeting (e.g., if the user would have otherwise stayed busy for more than an hour).

Similarly, block 46 may determine whether the user is offline, wherein the determination can be made again at block 42 as to whether any upcoming calendar events are scheduled. In response to detecting any such upcoming events, illustrated block 44 re-schedules the alarm notifications associated with those events to occur immediately.

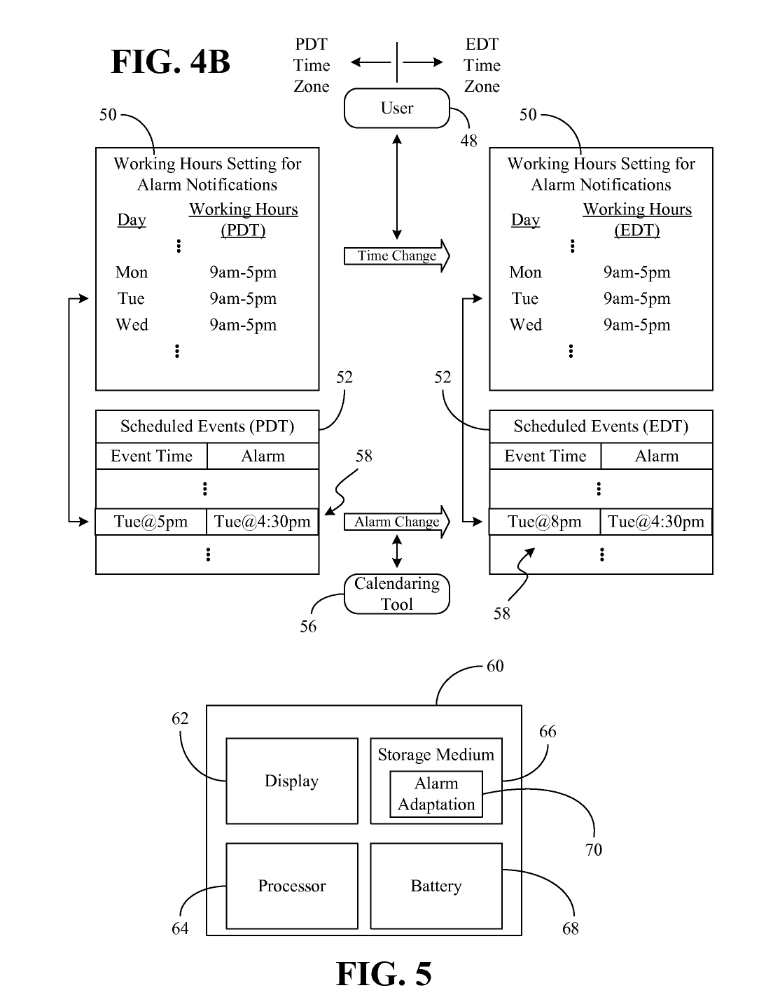

FIG. 4A shows an adaptation of an alarm notification in response to a working hours change. In the illustrated example, a user 48 has originally configured an alarm settings interface 50 to reflect that the user plans to work from 9 am to 5 pm Monday through Wednesday, wherein a calendar event table 52 contains a meeting 54 on Tuesday at 5 pm with a corresponding alarm notification at 4:30 pm. If the user subsequently changes his or her working hours to be from 7 am to 3 pm on Tuesday (e.g., due to a personal emergency), a calendaring tool 56 re-schedules the alarm notification for the 5 pm meeting 54 to occur at 3:30 pm (e.g., during the user's new working hour range), in the example shown.

FIG. 4B shows an adaptation of an alarm notification in response to a time zone change. In the illustrated example, while in the PDT (Pacific Daylight Time) time zone, the user 48 has configured an alarm settings interface 50 to reflect that the user plans to work from 9 am to 5 pm Monday through Wednesday. Additionally, the calendar event table 52 contains a meeting 58 on Tuesday at 5 pm PDT with a corresponding alarm notification at 4:30 pm PDT. If the user subsequently travels to the EDT (Eastern Daylight Time) time zone, the meeting 58 will occur at 8 pm EDT, in the example shown. Accordingly, the OS time of the user's device (e.g., handheld device, notebook computer) may automatically change to reflect the time zone of a mobile device network. If the user while keeps his or her working hours the same (i.e., 9 am to 5 pm EDT), the alarm notification may be automatically adapted by the calendaring tool 56 to occur during the working hours range in the new time zone (e.g., 4:30 pm EDT instead of 7:30 pm EDT, which would be outside the user's working hours range).

Turning now to FIG. 5, a device 60 is shown that may be used to schedule meeting, appointments, and so forth. The device 60 may therefore be a desktop computer, notebook computer, handheld device, or any other suitable computing device. In the illustrated example, the device 60 includes a display 62, a processor 64, a storage medium 66, and a battery 68. The storage medium 66 may include computer usable code 70, wherein if executed by the processor 64, the computer usable code 70 causes the device 60 to identify a calendar entry, identify a working hour range, and schedule an alarm notification for the calendar entry based on the working hour range, as already discussed. The alarm notification may be output via the display 62 or other suitable notification device (e.g., speaker, tactile feedback mechanism, etc.).

Techniques described herein may therefore obviate any need for a user to manually set different alarm notifications for different events, particularly for events that are scheduled outside of “regular” working hours. For example, alarms can be set to thirty minutes for meetings scheduled within regular working hours, to one day in advance for weekend meetings, and to thirty minutes before lunch for meetings scheduled immediately after lunch. Moreover, changes to these settings can be applied globally to all meetings that have not yet occurred, without requiring additional user involvement. Accordingly, the user can avoid the inconvenience of individually scheduling and updating alarm notifications based on working hours changes, time zone changes and/or changes in user status.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention can be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

We claim:

1. A computer implemented method comprising:
receiving a request to create a first calendar entry via a user interface;
creating the first calendar entry in response to the request;
obtaining a working hour range from a user profile;
determining that the first calendar entry is scheduled either outside the working hour range or at a beginning of the working hour range;
identifying a time range associated with a second calendar entry;
scheduling an alarm notification for the first calendar entry, wherein the alarm notification is to occur within the working hour range and outside the time range associated with the second calendar entry;
detecting a status change with respect to a user associated with the first calendar entry; and
re-scheduling the alarm notification in response to the status change.

2. The method of claim 1, wherein the status change corresponds to an instant messaging application.

3. The method of claim 1, wherein the status change indicates that the user is busy.

4. The method of claim 1, wherein the status change indicates that the user is offline.

5. The method of claim 1, further including:
detecting a time change in one or more of the working hour range and a time zone of a device associated with the first calendar entry; and
re-scheduling the alarm notification in response to the time change.

6. A computer program product comprising:
a computer readable storage medium; and
computer usable code stored on the computer readable storage medium, wherein if executed by a processor, the computer usable code causes a computer to:
receive a request to create a first calendar entry via a user interface;
create the first calendar entry in response to the request;
obtain a working hour range from a user profile;
determine that the first calendar entry is scheduled either outside the working hour range or at a beginning of the working hour range;
identify a time range associated with a second calendar entry;
schedule an alarm notification for the first calendar entry, wherein the alarm notification is to occur within the working hour range and outside the time range associated with the second calendar entry;
detect a status change with respect to a user associated with the first calendar entry; and
re-schedule the alarm notification in response to the status change.

7. The computer program product of claim 6, wherein the status change is to correspond to an instant messaging application.

8. The computer program product of claim 6, wherein the status change is to indicate that the user is busy.

9. The computer program product of claim 6, wherein the status change is to indicate that the user is offline.

10. The computer program product of claim 6, wherein the computer usable code, if executed, causes a computer to:
detect a time change in one or more of the working hour range and a time zone of a device associated with the first calendar entry; and
re-schedule the alarm notification in response to the time change.

11. A computer program product comprising:
a computer readable storage medium; and
computer usable code stored on the computer readable storage medium, wherein if executed by a processor, the computer usable code causes a computer to:
identify a first calendar entry;
identify a working hour range; and
schedule an alarm notification for the first calendar entry based on the working hour range.

12. The computer program product of claim 11, wherein the computer usable code, if executed, causes a computer to:
determine that the first calendar entry is scheduled either outside the working hour range or at a beginning of the working hour range; and
adapt the alarm notification to occur within the working hour range.

13. The computer program product of claim 12, wherein the computer usable code, if executed, causes a computer to:
identify a time range associated with a second calendar entry; and
adapt the alarm notification to occur outside the time range associated with the second calendar entry.

14. The computer program product of claim 11, wherein the computer usable code, if executed, causes a computer to:
detect a status change with respect to a user associated with the first calendar entry; and
re-schedule the alarm notification in response to the status change.

15. The computer program product of claim 14, wherein the status change is to correspond to an instant messaging application.

16. The computer program product of claim 14, wherein the status change is to indicate that the user is busy.

17. The computer program product of claim 14, wherein the status change is to indicate that the user is offline.

18. The computer program product of claim 11, wherein the computer usable code, if executed, causes a computer to:
detect a time change in one or more of the working hour range and a time zone change of a device associated with the first calendar entry; and
re-schedule the alarm notification in response to the time change.

19. The computer program product of claim 11, wherein the computer usable code, if executed, causes a computer to:
receive a request to create the first calendar entry via a user interface; and
create the first calendar entry in response to the request.

20. The computer program product of claim 11, wherein the computer usable code, if executed, causes a computer to obtain the working hour range from a user profile.
